(19) United States
(12) Patent Application Publication
(10) Pub. No.: US 2025/0226442 A1
(43) Pub. Date: Jul. 10, 2025

(54) POLYACRYLAMIDE ELECTROLYTES FOR BATTERIES THAT CYCLE LITHIUM IONS AND BATTERIES INCLUDING THE SAME

(71) Applicant: GM GLOBAL TECHNOLOGY OPERATIONS LLC, Detroit, MI (US)

(72) Inventors: Sanaz KETABI, Rochester Hiils, MI (US); Nathaniel Hardin, Farmington Hills, MI (US); Fang Dai, Troy, MI (US); Manuela Ferreira Borras, Dearborn, MI (US)

(21) Appl. No.: 18/404,008

(22) Filed: Jan. 4, 2024

(51) Int. Cl. H01M 10/0565

(52) U.S. Cl. CPC H01M 10/0565; H01M 2300/0085

(57) ABSTRACT

An electrolyte for a battery that cycles lithium ions includes a polyacrylamide and a liquid electrolyte immobilized in the polyacrylamide. The polyacrylamide includes acrylamide monomers covalently bonded to one another. The liquid electrolyte includes a lithium salt in an organic solvent.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to electrolytes for batteries that cycle lithium ions, and more particularly to electrolytes including a polymer matrix and a liquid electrolyte immobilized in the polymer matrix.

Batteries that cycle lithium ions generally include a positive electrode, a negative electrode spaced apart from the positive electrode, and an ionically conductive electrolyte that provides a medium for the conduction of lithium ions between the positive and negative electrodes during discharge and charge of the batteries. The electrolyte may be formulated to exhibit certain desirable properties including high ionic conductivity, good thermal stability, a wide electrochemical stability window, ability to form a stable ionically conductive solid electrolyte interphase on the surface of the positive electrode and/or the negative electrode, and chemical compatibility with other components of the batteries.

### SUMMARY

An electrolyte for a battery that cycles lithium ions, in accordance with one or more embodiments of the present disclosure, comprises a polyacrylamide and a liquid electrolyte immobilized in the polyacrylamide. The polyacrylamide comprises acrylamide monomers covalently bonded to one another. The liquid electrolyte comprises a lithium salt in an organic solvent.

The acrylamide monomers may comprise acrylamide, N-alkylacrylamide, N-cycloalkylacrylamide, dialkylacrylamide, hydroxyalkylacrylamides, N-arylacrylamides, methacrylamide, N-alkyl methacrylamide, N-cycloalkyl methacrylamide, dialkyl methacrylamide, dialkylaminoalkyl methacrylamide, hydroxyalkyl methacrylamide, N-arylmethacrylamide, 2-acrylamido-2-methyl-1-propanesulfonic acid, 2-acrylamido-2-methyl-propanephosphonic acid, or a combination thereof.

At least one of the acrylamide monomers may comprise a substituent selected from the group consisting of silyl, siloxy, alkoxysilyl, sulfo, phosphate, and carboxamide.

The polyacrylamide may further comprise an alkylene bisacrylamide crosslinker. In such case, the acrylamide monomers and the alkylene bisacrylamide crosslinker may be covalently bonded to one another to form a three-dimensional network of interconnected polyacrylamide chains.

The polyacrylamide may further comprise an acrylonitrile monomer. In such case, the acrylamide monomers and the acrylonitrile monomer may be covalently bonded to one another.

The polyacrylamide may comprise a polymer having the formula (1):

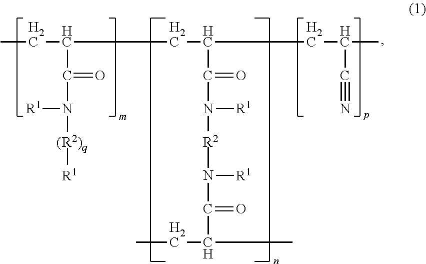

wherein: m is an integer; n is zero or an integer; p is zero or an integer; q is zero or 1; R¹, R³, R⁴, and R⁵ are each individually H, hydroxyl, hydrocarbyl, heterohydrocarbyl, silyl, siloxy, alkoxysilyl, sulfo, phosphate, or carboxamide moiety; R² is a divalent hydrocarbyl or heterohydrocarbyl, and the sum of m+n+p is greater than or equal to 100 and less than or equal to 200,000.

The organic solvent may comprise an ether-based solvent. The lithium salt may comprise lithium hexafluorophosphate (LiPF₆), lithium bis(trifluoromethane)sulfonylimide (LiTFSI), lithium bis(fluorosulfonyl)imide (LiFSI), or a combination thereof.

The electrolyte may further comprise an additive comprising lithium nitrate (LiNO₃).

A battery that cycles lithium ions, in accordance with one or more embodiments of the present disclosure, comprises a negative electrode, a positive electrode spaced apart from the negative electrode by a gap, and a polymer electrolyte disposed within the gap between the negative electrode and the positive electrode. The negative electrode comprises an electroactive negative electrode material. The positive electrode comprises an electroactive positive electrode material. The polymer electrolyte comprises a polyacrylamide and a liquid electrolyte immobilized in the polyacrylamide. The polyacrylamide comprises acrylamide monomers covalently bonded to one another. The liquid electrolyte comprises a lithium salt in an organic solvent.

The acrylamide monomers may comprise acrylamide, N-alkylacrylamide, N-cycloalkylacrylamide, dialkylacrylamide, hydroxyalkylacrylamides, N-arylacrylamides, methacrylamide, N-alkyl methacrylamide, N-cycloalkyl methacrylamide, dialkyl methacrylamide, dialkylaminoalkyl methacrylamide, hydroxyalkyl methacrylamide, N-arylmethacrylamide, 2-acrylamido-2-methyl-1-propanesulfonic acid, 2-acrylamido-2-methyl-propanephosphonic acid, or a combination thereof.

At least one of the acrylamide monomers may comprise a substituent selected from the group consisting of silyl, siloxy, alkoxysilyl, sulfo, phosphate, and carboxamide.

The polyacrylamide may further comprise an alkylene bisacrylamide crosslinker. In such case, the acrylamide monomers and the alkylene bisacrylamide crosslinker may be covalently bonded to one another to form a three-dimensional network of interconnected polyacrylamide chains.

The polyacrylamide may further comprise an acrylonitrile monomer. In such case, the acrylamide monomers and the acrylonitrile monomer may be covalently bonded to one another.

The polyacrylamide may comprise a polymer having the formula (1):

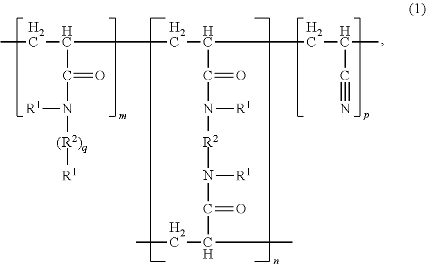

wherein: m is an integer; n is zero or an integer; p is zero or an integer; q is zero or 1; R¹, R³, R⁴, and R⁵ are each individually H, hydroxyl, hydrocarbyl, heterohydrocarbyl, silyl, siloxy, alkoxysilyl, sulfo, phosphate, or carboxamide moiety; R² is a divalent hydrocarbyl or heterohydrocarbyl, and the sum of m+n+p is greater than or equal to 100 and less than or equal to 200,000.

The organic solvent may comprise an ether-based solvent. The lithium salt may comprise lithium hexafluorophosphate (LiPF₆), lithium bis(trifluoromethane)sulfonylimide (LiTFSI), lithium bis(fluorosulfonyl)imide (LiFSI), or a combination thereof.

The liquid electrolyte may further comprise an additive comprising lithium nitrate (LiNO₃).

The electroactive positive electrode material may comprise a sulfur-based material.

The electroactive negative electrode material may comprise nonporous lithium.

A method of manufacturing a battery that cycles lithium ions, in accordance with one or more embodiments of the present disclosure, comprises a step of assembling a stack comprising a negative electrode and a positive electrode, wherein the negative electrode and the positive electrode are spaced apart from each other by a gap. The stack is infiltrated with an electrolyte precursor comprising acrylamide monomers, a radical initiator, and a liquid electrolyte. Free radical polymerization of the acrylamide monomers is initiated such that the acrylamide monomers covalently bond to one another and form a polyacrylamide.

The radical initiator may comprise an azo compound, an organic peroxide, or a combination thereof. Free radical polymerization of the acrylamide monomers is initiated by heating the electrolyte precursor at a temperature of greater than or equal to 70 degrees Celsius.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a schematic perspective view of an automotive vehicle powered by a battery pack that includes multiple battery modules.

FIG. 2 is a schematic cross-sectional view of a portion of one of the battery modules of FIG. 1, the battery module including multiple electrochemical cells or batteries that cycle lithium ions.

FIG. 3 is a schematic cross-sectional view of a battery that cycles lithium ions, the battery comprising a positive electrode, a negative electrode, and a polymer electrolyte disposed between the positive electrode and the negative electrode.

In the drawings, reference numbers may be reused to identify similar and/or identical elements.

### DETAILED DESCRIPTION

### Definitions

“Hydrocarbyl” means a functional group containing only hydrogen and carbon atoms, including branched or unbranched, saturated or unsaturated, cyclic, polycyclic or acyclic groups. Hydrocarbyls are formed by removing at least one hydrogen atom from a hydrocarbon molecule. According to the number of removed hydrogen atoms, a hydrocarbyl can be monovalent (formed by removing one hydrogen atom, also referred to as a hydrocarbyl group), divalent (formed by removing two hydrogen atoms, also referred to as a hydrocarbylene group), and the like. Examples of monovalent hydrocarbyls include alkyl, cycloalkyl, alkenyl, cycloalkenyl, aryl, and alkynyl groups. Examples of divalent hydrocarbyls include alkylene, cycloalkylene, alkenylene, alkynylene, and arylene groups.

“Heterohydrocarbyl” means a hydrocarbyl in which at least one of the carbon atoms is replaced with a heteroatom, e.g., nitrogen, oxygen, sulfur, phosphorus, boron, or silicon. Examples of heterohydrocarbyls include alkoxy, aryloxy, —CH₂OCH₃, and oxyalkylene (e.g., —CH₂CH₂O—).

“Carboxamide” refers to a compound, moiety, or functional group having the formula R′—C(═O)—NR″R″, where R′, R″, and R″ are each individually H, hydrocarbyl, or heterohydrocarbyl.

“Substituted” refers to a compound, moiety, or functional group in which at least one hydrogen atom bound to a carbon atom is replaced with a substituent that is a functional group. Examples of substituents include hydroxyl (—OH), heterohydrocarbyl, phosphate, amino, halo, silyl, and sulfo groups.

“Silyl” means a functional group having the formula —SiR′R″R″, where R′, R″, and R″ are each individually H, hydrocarbyl, or heterohydrocarbyl.

“Siloxy” means a functional group having the formula —OSiR′R″R″, where R′, R″, and R″ are each individually H, hydrocarbyl, or heterohydrocarbyl.

“Alkoxysilyl” means a functional group having the formula —Si(OR)₃, where R is H, hydrocarbyl, heterohydrocarbyl, or —Si(OR)₃.

“Sulfo” means a functional group having the formula —SO₃R, where R is H, hydrocarbyl, or heterohydrocarbyl.

“Phosphate” means a functional group having the formula —OPO(OR)₂, where R is H, hydrocarbyl, or heterohydrocarbyl.

Expressions such as “at least one of A, B, and C” should be construed to mean a logical (A OR B OR C), using a non-exclusive logical OR, and should not be construed to mean “at least one of A, at least one of B, and at least one of C.”

The term “and/or” includes combinations of one or more of the associated listed items.

The singular forms “a,” “an,” and “the” may be intended to include the plural forms as well, unless the context clearly indicates otherwise.

The terms “comprises,” “comprising,” “including,” and “having,” are inclusive and therefore specify the presence of stated features, elements, compositions, steps, integers, operations, and/or components, but do not preclude the presence or addition of one or more other features, integers, steps, operations, elements, components, and/or groups thereof. Although the open-ended terms “comprises,” “comprising,” “including,” and “having,” are to be understood as non-restrictive terms used to describe and claim various embodiments set forth herein, in certain aspects, the terms may alternatively be understood to instead be a more limiting and restrictive term, such as “consisting of” or “consisting essentially of.” Thus, for any given embodiment reciting compositions, materials, components, elements, ingredients, features, integers, operations, and/or process steps, the present disclosure also specifically includes embodiments consisting of, or consisting essentially of, such recited compositions, materials, components, elements, ingredients, features, integers, operations, and/or process steps.

The terms “composition” and “material” are used interchangeably to refer broadly to a substance containing at least the preferred chemical constituents, elements, or compounds, but which may also comprise additional elements, compounds, or substances, including trace amounts of impurities (i.e., in amounts less than or equal to 0.1%). An “X-based” composition or material broadly refers to compositions or materials in which “X” is the single largest constituent of the composition or material on a weight percentage (%) basis. This may include compositions or materials having, by weight, greater than 50% X, as well as those having, by weight, less than 50% X, so long as X is the single largest constituent of the composition or material based upon its overall weight. When a composition or material is referred to as being “substantially free” of a substance, the composition or material may comprise, by weight, less than 5%, optionally less than 3%, optionally less than 1%, or optionally less than 0.1% of the substance.

The term “metal” may refer to a pure elemental metal or to an elemental metal and one or more other metal or nonmetal elements. The term “elemental metal” means that the relevant metal is present in its purest form and does not contain any other elements, except in trace amounts, i.e., as impurities.

### Embodiments

The presently disclosed polymer electrolytes can be used in batteries that cycle lithium ions to help reduce interfacial resistance between the electrolyte and the positive and negative electrodes, which may help improve the electrochemical performance of the batteries. When used in batteries that comprise sulfur-based electroactive positive electrode materials, the polymer electrolytes may help prevent or inhibit polysulfide dissolution and shuttling between the positive and negative electrodes, which may help improve the cycle life and coulombic efficiency of the batteries. In addition, when used in batteries that comprise nonporous lithium metal negative electrodes, the polymer electrolytes may help promote the homogeneous deposition of metallic lithium, thereby avoiding the undesirable nucleation and growth of lithium dendrites. The presently disclosed polymer electrolytes comprise a polyacrylamide and a liquid electrolyte immobilized in the polyacrylamide. The amide groups in the polyacrylamide may help bind acid species, chelate metal ions, and absorb polysulfide species, thereby improving the cycle life of the batteries.

FIG. 1 depicts an automotive vehicle 2 powered by an electric motor 4 that draws electricity from a battery pack 6 including one or more battery modules 8. The battery modules 8 may be electrically coupled together in a series and/or parallel arrangement to meet desired capacity and power requirements of the electric motor 4. The vehicle 2 may be an all-electric vehicle and may be powered exclusively by the electric motor 4, or the vehicle 2 may be a hybrid electric vehicle and may be powered by the electric motor 4 and by an internal combustion engine (not shown).

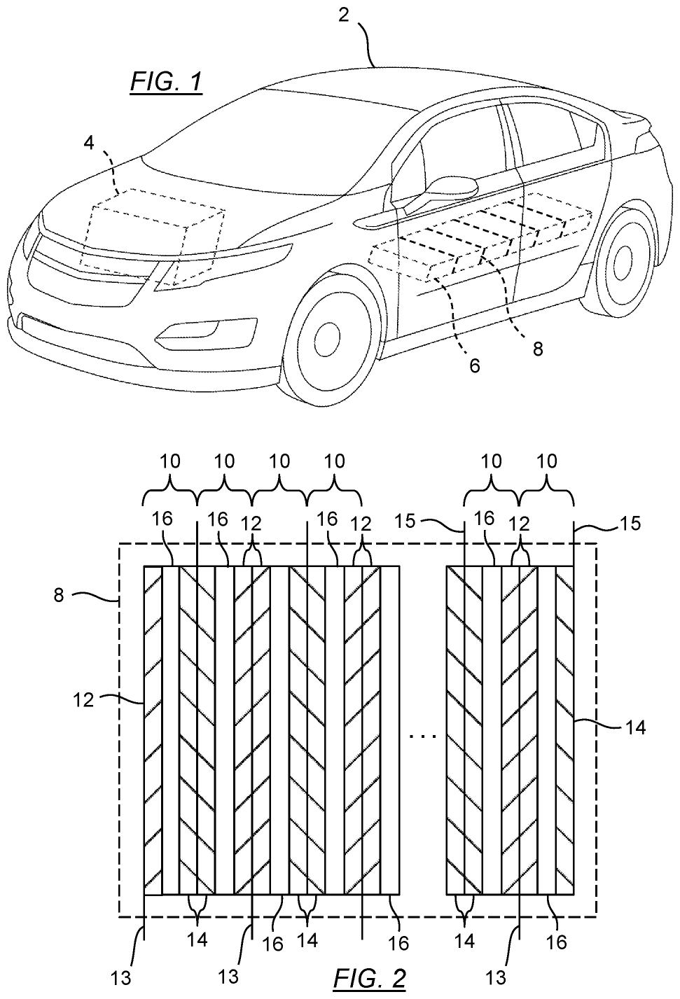

As shown in FIG. 2, each battery module 8 includes one or more electrochemical cells or batteries 10 that cycle lithium ions. In practice, the batteries 10 in the battery module 8 are oftentimes assembled as a stack of layers, including negative electrode layers 12, negative electrode current collectors 13, positive electrode layers 14, positive electrode current collectors 15, and separator layers 16. Each battery 10 is defined by a negative electrode layer 12 and a positive electrode layer 14, which are spaced apart from each other by a separator layer 16. In practice, the separator layer 16 may be infiltrated with an electrolyte that provides a medium for the conduction of lithium ions between the negative electrode layer 12 and the positive electrode layer 14, or the separator layer 16 itself may function as an electrolyte. The negative electrode layers 12 are disposed on and in electrical communication with the negative electrode current collectors 13 and the positive electrode layers 14 are disposed on an in electrical communication with the positive electrode current collectors 15. As shown in FIG. 2, for efficiency, the layers may be stacked such that some of the negative electrode current collectors 13 and some of the positive electrode current collectors 15 are double sided and respectively include negative electrode layers 12 or positive electrode layers 14 on both sides thereof. In this arrangement, adjacent negative electrode layers 12 and positive electrode layers 14 respectively share a single negative electrode current collector 13 or a positive electrode current collector 15.

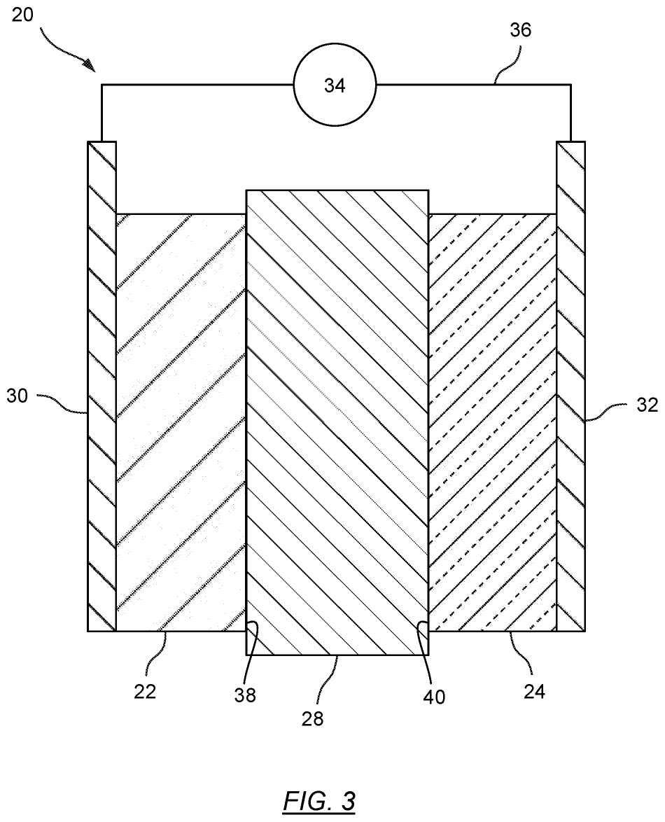

FIG. 3 depicts an electrochemical cell or battery 20 that cycles lithium ions. The battery 20 can generate an electric current during discharge, which may be used to supply power to a load device (e.g., the electric motor 4), and can be charged by being connected to a power source. Like the batteries 10 depicted in FIGS. 1 and 2, in aspects, the battery 20 may be used to supply power to an electric motor 4 of an automotive vehicle 2. Additionally or alternatively, the battery 20 may be used in other transportation applications (e.g., motorcycles, boats, tractors, buses, motorcycles, mobile homes, campers, tanks, and aircraft), and may be used to provide electricity to stationary and/or portable electronic equipment, components, and devices used in a wide variety of other industries and applications, including industrial, residential, and commercial buildings, consumer products, industrial equipment and machinery, agricultural or farm equipment, and heavy machinery, by way of nonlimiting example.

The battery 20 comprises a negative electrode 22, a positive electrode 24, and a polymer electrolyte 28 disposed between a facing surface 38 of the negative electrode 22 and an opposing facing surface 40 of the positive electrode 24. The negative electrode 22 is disposed on a major surface of a negative electrode current collector 30 and the positive electrode 24 is disposed on a major surface of a positive electrode current collector 32. In practice, the negative electrode current collector 30 and the positive electrode current collector 32 are electrically coupled to a power source or load 34 (e.g., the electric motor 4) via an external circuit 36. The negative electrode 22 and the positive electrode 24 are formulated such that, when the battery 20 is at least partially charged, an electrochemical potential difference is established between the negative electrode 22 and the positive electrode 24. During discharge of the battery 20, the electrochemical potential established between the negative electrode 22 and the positive electrode 24 drives spontaneous reduction and oxidation (redox) reactions within the battery 20 and the release of lithium ions and electrons from the negative electrode 22. The released lithium ions travel from the negative electrode 22 to the positive electrode 24 through the polymer electrolyte 28, while the electrons travel from the negative electrode 22 to the positive electrode 24 via the external circuit 36, which generates an electric current. After the negative electrode 22 has been partially or fully depleted of lithium, the battery 20 may be charged by connecting the negative electrode 22 and the positive electrode 24 to the power source 34, which drives nonspontaneous redox reactions within the battery 20 and the release of the lithium ions and the electrons from the positive electrode 24. The repeated discharge and charge of the battery 20 may be referred to herein as “cycling,” with a full charge event followed by a full discharge event being considered a full cycle.

The positive electrode 24 is formulated to store and release lithium ions during discharge and charge of the battery 20. The positive electrode 24 may be in the form of a continuous porous layer disposed on the major surface of the positive electrode current collector 32 and having open pores extending therethrough. The positive electrode 24 comprises an electrochemically active (electroactive) material (electroactive positive electrode material), a polymer binder, and optionally an electrically conductive material. In aspects, the electroactive material of the positive electrode 24 may be a particulate material and particles of the electroactive material of the positive electrode 24 may be intermingled with the polymer binder and the optional electrically conductive material.

The electroactive material of the positive electrode 24 can store and release lithium ions by undergoing a reversible redox reaction with lithium at a higher electrochemical potential than the electroactive material of the negative electrode 22 such that an electrochemical potential difference exists between the negative electrode 22 and the positive electrode 24. The electroactive material of the positive electrode 24 may comprise a material that can undergo lithium intercalation and deintercalation or a material that can undergo a conversion reaction with lithium. In embodiments where the electroactive material of the positive electrode 24 comprises an intercalation host material that can undergo the reversible insertion or intercalation of lithium ions, the electroactive material of the positive electrode 24 may comprise a lithium transition metal oxide. For example, the electroactive material of the positive electrode 24 may comprise a layered lithium transition metal oxide represented by the formula LiMeO₂ and/or Li₂MeO₃, a layered lithium-rich transition metal oxide represented by the formula Li₁₊ₓMe₁₋ₓO₂ (where 0<x≤0.33), an olivine-type lithium transition metal oxide represented by the formula LiMePO₄, a monoclinic-type lithium transition metal oxide represented by the formula Li₃Me₂(PO₄)₃, a spinel-type lithium transition metal oxide represented by the formula LiMe₂O₄, a tavorite represented by one or both of the following formulas LiMeSO₄F or LiMePO₄F, or a combination thereof, where Me is a transition metal (e.g., Co, Ni, Mn, Fe, Al, V, or a combination thereof). In embodiments where the electroactive material of the positive electrode 24 comprises a conversion material, the electroactive material of the positive electrode 24 may comprise sulfur, selenium, tellurium, iodine, a halide (e.g., a fluoride or chloride), sulfide, selenide, telluride, iodide, phosphide, nitride, oxide, oxysulfide, oxyfluoride, sulfur-fluoride, sulfur-oxyfluoride, or a lithium and/or metal compound thereof (e.g., a compound of iron, manganese, nickel, copper, and/or cobalt).

In embodiments, the electroactive material of the positive electrode 24 may comprise a sulfur-based material. In embodiments, the electroactive material of the positive electrode 24 may comprise a composite material including sulfur and/or a sulfur-based material distributed within an electrically conductive matrix material. Examples of electrically conductive matrix materials include carbon-based materials, metal compounds, conductive polymers, and combinations thereof. Examples of electrically conductive carbon-based matrix materials include graphene, reduced graphene oxide, carbon nanotubes (CNTs), hierarchical porous carbon, hollow structured carbon, and combinations thereof. Examples of metal compound matrix materials include manganese oxide (MnO₂), titanium oxide (TiO₂), iron oxide (Fe₂O₃), vanadium oxide (V₂O₅), cobalt sulfide (CoS₂ and/or Co₉S₈), titanium sulfide (TiS), titanium nitride (TiN), titanium carbide (Ti₂C), lithium sulfide (Li₂S), and combinations thereof. Examples of electrically conductive polymer matrix materials include polyacrylonitrile (PAN), polypyrrole, polythiophene, poly(3,4-ethylenedioxythiophene) (PEDOT), and combinations thereof. In embodiments, the electroactive material of the positive electrode 24 may comprise sulfurized polyacrylonitrile (SPAN).

The electroactive material of the positive electrode 24 may constitute, by weight, greater than or equal to about 50%, optionally greater than or equal to about 60%, or optionally greater than or equal to about 70% and less than or equal to about 95%, optionally less than or equal to about 90%, or optionally less than or equal to about 80% of the positive electrode 24.

The polymer binder is electrochemically inactive and may be included in the positive electrode 24 to provide the positive electrode 24 with structural integrity and/or to help the positive electrode 24 adhere to the major surface of the positive electrode current collector 32. Examples of polymer binders include polyvinylidene fluoride (PVdF), polytetrafluoroethylene (PTFE), ethylene propylene diene monomer (EPDM) rubber, styrene butadiene rubber (SBR), carboxymethyl cellulose (CMC), nitrile butadiene rubber (NBR), styrene-butadiene rubber (SBR), styrene ethylene butylene styrene copolymer (SEBS), polyvinyl alcohol (PVA), polyvinylpyrrolidone (PVP), polyacrylates, alginates, polyacrylic acid, and combinations thereof. The polymer binder may constitute, by weight, greater than or equal to about 1%, or optionally greater than or equal to about 5%, and less than or equal to about 10% of the positive electrode 24.

The optional electrically conductive material is electrochemically inactive and may be included in the positive electrode 24 to provide the positive electrode 24 with sufficient electrical conductivity to support the percolation of electrons therethrough. Examples of electrically conductive materials include carbon-based materials, metals (e.g., nickel), and/or electrically conductive polymers. Examples of electrically conductive carbon-based materials include carbon black (CB) (e.g., acetylene black), graphite, graphene (e.g., graphene nanoplatelets, GNP), graphene oxide, carbon nanotubes (CNT), and/or carbon fibers (e.g., carbon nanofibers). Examples of electrically conductive polymers include polyaniline, polythiophene, polyacetylene, and/or polypyrrole. When included in the positive electrode 24, the optional electrically conductive material may constitute, by weight, greater than 0%, optionally greater than or equal to about 1%, or optionally greater than or equal to about 5% and less than or equal to about 10% of the positive electrode 24.

The negative electrode 22 is formulated to store and release lithium ions to facilitate charge and discharge, respectively, of the battery 20. The negative electrode 22 may be in the form of a continuous layer of material disposed on a major surface of the negative electrode current collector 30. The negative electrode 22 comprises an electrochemically active (electroactive) material (electroactive negative electrode material) that can store and release lithium ions by undergoing a reversible redox reaction with lithium during charge and discharge of the battery 20. Examples of electroactive negative electrode materials include lithium, lithium-based materials (e.g., alloys of lithium and silicon, aluminum, indium, and/or tin), carbon-based materials (e.g., graphite, activated carbon, carbon black, hard carbon, soft carbon, and/or graphene), silicon, silicon-based materials (e.g., alloys of silicon and lithium, tin, iron, aluminum, and/or cobalt), silicon oxide, silicon oxide-based materials (e.g., lithium silicon oxide), tin oxide, aluminum, indium, zinc, germanium, titanium oxide, lithium titanate, and combinations thereof.

In some embodiments, the negative electrode 22 may be porous and may have open pores extending therethrough. In such case, the electroactive material of the negative electrode 22 may be a particulate material, and particles of the electroactive material of the negative electrode 22 may be intermingled with a polymer binder and optionally an electrically conductive material. In such case, the electroactive material of the negative electrode 22 may constitute, by weight, greater than or equal to about 50%, optionally greater than or equal to about 60%, or optionally greater than or equal to about 70% and less than or equal to about 95%, optionally less than or equal to about 90%, or optionally less than or equal to about 80% of the negative electrode 22. The same polymer binders and/or electrically conductive materials disclosed above with respect to the positive electrode 24 may be used in the negative electrode 22 in substantially the same amounts.

In other embodiments, the electroactive material of the negative electrode 22 may consist of lithium and the negative electrode 22 may be in the form of a nonporous metal film or foil, such as a lithium metal film or lithium metal foil. In such case, the negative electrode 22 may comprise, by weight, greater than 97% lithium, or optionally greater than 99% lithium. In embodiments where the electroactive material of the negative electrode 22 consists of lithium, the negative electrode 22 may be substantially free of elements or compounds that undergo a reversible redox reaction with lithium during operation of the battery 20. In addition, in such embodiments, the negative electrode 22 may be substantially free of a polymer binder.

The polymer electrolyte 28 is ionically conductive and is formulated to provide a medium for the conduction of lithium ions between the negative electrode 22 and the positive electrode 24. The polymer electrolyte 28 physically separates and electrically isolates the negative electrode 22 and the positive electrode 24 from each other while permitting lithium ions to pass therethrough. The polymer electrolyte 28 may be sandwiched between the negative electrode 22 and the positive electrode 24 and may be in direct physical contact with the opposing facing surfaces 38, 40 of the negative electrode 22 and the positive electrode 24. In embodiments where the negative electrode 22 and/or the positive electrode 24 are porous, the polymer electrolyte 28 may at least partially infiltrate the open pores thereof. The polymer electrolyte 28 comprises a polyacrylamide, a liquid electrolyte immobilized in the polyacrylamide, and optionally a support structure. The polymer electrolyte 28 may have a thickness of greater than or equal to 5 micrometers (μm), optionally greater than or equal to 10 μm, or optionally greater than or equal to 20 μm and less than or equal to 500 μm, optionally less than or equal to 200 μm, or optionally less than or equal to 50 μm.

The polyacrylamide is formulated to provide the polymer electrolyte 28 with flexibility and the ability to establish robust interfacial contact with the facing surface 38 of the negative electrode 22 and with the facing surface 40 of the positive electrode 24, which may help reduce interfacial resistance between the polymer electrolyte 28 and the negative and positive electrodes 22, 24. In addition, in embodiments where the electroactive material of the positive electrode 24 comprises a sulfur-based material, the polyacrylamide may help prevent polysulfides produced in the positive electrode 24 from diffusing through the polymer electrolyte 28 and undesirably reacting with lithium metal in the negative electrode 22 to form insoluble polysulfides and thereby reducing the cycle life and coulombic efficiency of the battery 20 (a phenomenon known as polysulfide dissolution and shuttling). Furthermore, in embodiments where the negative electrode 22 consists of nonporous lithium, the polyacrylamide may help provide the battery 20 with low ion concentration polarization at the interface between the negative electrode 22 and the polymer electrolyte 28, which may help promote the homogeneous deposition of metallic lithium on the facing surface 38 of the negative electrode 22, thereby hindering the undesirable nucleation and growth of lithium dendrites. The polyacrylamide may constitute, by weight, greater than or equal to 1%, optionally greater than or equal to 5%, and less than or equal to 30%, optionally less than or equal to 20%, or optionally less than or equal to 10% of the polymer electrolyte 28.

The polyacrylamide comprises an acrylamide monomer, optionally an alkylene bisacrylamide crosslinker, and optionally an acrylonitrile monomer. In the polyacrylamide, the acrylamide monomer, the optional alkylene bisacrylamide crosslinker, and the optional acrylonitrile monomer are covalently bonded to one another. In embodiments, the polyacrylamide may be a homopolymer or a copolymer having the formula (1):

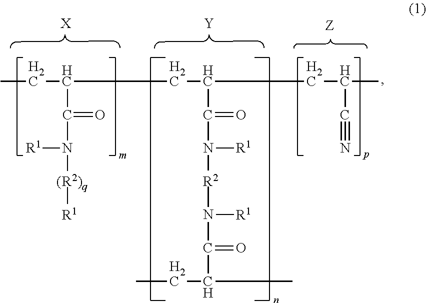

where X is an acrylamide monomer; Y is an alkylene bisacrylamide crosslinker; Z is an acrylonitrile monomer; m is an integer; n is zero or an integer; p is zero or an integer; q is zero or 1; R¹, R³, R⁴, and R⁵ are each individually H, hydroxyl, hydrocarbyl, heterohydrocarbyl, silyl, siloxy, alkoxysilyl, sulfo, phosphate, or carboxamide moiety; and R² is a divalent hydrocarbyl or heterohydrocarbyl. In embodiments, the sum of m+n+p may be greater than or equal to 100 and less than or equal to 200,000.

Examples of acrylamide monomers include acrylamide; N-alkylacrylamides (e.g., N-methylacrylamide, N-ethylacrylamide, N-n-propylacrylamide, N-isopropylacrylamide, N-n-butylacrylamide, and N-tert-butylacrylamide); N-cycloalkylacrylamides (e.g., N-cyclohexylacrylamide); dialkylacrylamides (e.g., N,N-dimethylacrylamide and N,N-diallylacrylamide); dialkylaminoalkyl acrylamides; hydroxyalkylacrylamides; N-arylacrylamides; methacrylamide; N-alkyl methacrylamides (e.g, N-methyl methacrylamide, N-ethyl methacrylamide, N-n-propyl methacrylamide, N-isopropyl methacrylamide, N-n-butyl methacrylamide, and

N-tert-butyl methacrylamide); N-cycloalkyl methacrylamides; dialkyl methacrylamides (e.g., N,N-dimethyl methacrylamide); dialkylaminoalkyl methacrylamides; hydroxyalkyl methacrylamides; N-arylmethacrylamides; 2-acrylamido-2-methyl-1-propanesulfonic acid; 2-acrylamido-2-methyl-propanephosphonic acid; and combinations thereof.

Examples of alkylene bisacrylamide crosslinkers include N,N′-methylene bisacrylamide, N,N′-ethylene bisacrylamide, and combinations thereof.

Examples of acrylonitrile monomers include acrylonitrile, methacrylonitrile, 2-hydroxyethylacrylonitrile, methoxyacrylonitrile, methoxymethacrylonitrile, and combinations thereof.

In embodiments, the acrylamide monomers, the optional alkylene bisacrylamide crosslinker, the optional acrylonitrile monomer, and/or the functional groups thereof may be substituted or unsubstituted.

In embodiments where the polyacrylamide comprises the optional alkylene bisacrylamide crosslinker (i.e., where n is an integer greater than or equal to 1), the acrylamide monomers and the alkylene bisacrylamide crosslinker are covalently bonded to one another and may form a three-dimensional network of interconnected polyacrylamide chains, with each polyacrylamide chain comprising two or more acrylamide monomers.

The liquid electrolyte infiltrates the polyacrylamide and is formulated to provide the polymer electrolyte 28 with good ionic conductivity. The liquid electrolyte comprises an organic solvent, a lithium salt in the organic solvent, and optionally an additive. The liquid electrolyte may constitute, by weight, greater than or equal to 70%, or optionally greater than or equal to 80%, and less than or equal to 99%, or optionally less than or equal to 95%, or optionally less than or equal to 90% of the polymer electrolyte 28.

The organic solvent may comprise a nonaqueous aprotic organic solvent. Non-limiting examples of non-aqueous aprotic organic solvents include cyclic carbonates (e.g., ethylene carbonate (EC), propylene carbonate (PC), butylene carbonate (BC), fluoroethylene carbonate (FEC), and vinylene carbonate (VC)); linear carbonates (e.g., dimethyl carbonate (DMC), diethyl carbonate (DEC), ethyl methyl carbonate (EMC)); aliphatic ethers (e.g., triethylene glycol dimethyl ether, tetraethylene glycol dimethyl ether, 1,3-dimethoxypropane, 1,2-dimethoxyethane (DME), 1-2-diethoxyethane, and/or ethoxymethoxyethane); cyclic ethers (e.g., 1,4-dioxane, tetrahydrofuran, 2-methyltetrahydrofuran, and/or 1,3-dioxolane (DOL)); and combinations thereof. In embodiments, the organic solvent may comprise an ether-based solvent. For example, in embodiments, the organic solvent may comprise a mixture of a cyclic ether (e.g., DOL) and an aliphatic ether (e.g., DME). In such case, the cyclic ether and the aliphatic ether may be included in the liquid electrolyte at a volumetric ratio of about 1:1.

The lithium salt is soluble in the organic solvent and provides a passage for lithium ions through the polymer electrolyte 28. The lithium salt may comprise an inorganic lithium salt, an organic lithium salt, or a combination thereof. Examples of lithium salts include lithium hexafluorophosphate (LiPF₆), lithium difluorophosphate (LiPO₂F₂), lithium perchlorate (LiClO₄), lithium tetrachloroaluminate (LiAlCl₄), lithium iodide (LiI), lithium bromide (LiBr), lithium thiocyanate (LiSCN), lithium tetrafluoroborate (LiBF₄), lithium hexafluoroarsenate (LiAsF₆), lithium trifluoromethanesulfonate (LiCF₃SO₃), lithium bis(trifluoromethane)sulfonylimide (LiN(CF₃SO₂)₂) (LiTFSI), lithium bis(fluorosulfonyl)imide (LiN(FSO₂)₂) (LiFSI), lithium tetraphenylborate (LiB(C₆H₅)₄), lithium bis(oxalato)borate (LiB(C₂O₄)₂) (LiBOB), lithium difluoro (oxalato) borate (LiBF₂(C₂O₄)) (LiDFOB), and combinations thereof. In aspects, the lithium salt may comprise LiFSI, LiTFSI, LiPF₆, or a combination thereof. The lithium salt may be dissolved in the organic solvent at a concentration of greater than or equal to about 0.5 Molar and less than or equal to about 1.5 Molar. In aspects, the lithium salt may be dissolved in the organic solvent at a concentration of about 1 Molar. The lithium salt may constitute, by weight, greater than or equal to about 5%, optionally greater than or equal to about 10%, and less than or equal to about 20%, or optionally less than or equal to about 15% of the polymer electrolyte 28.

The optional additive is soluble in the organic solvent and may be formulated to help prevent or suppress polysulfide dissolution and shuttling. Examples of additives include lithium nitrate (LiNO₃). When present, the optional additive may be dissolved in the organic solvent at a concentration of greater than or equal to about 0.1 Molar and less than or equal to about 0.5 Molar. In aspects, the optional additive may be dissolved in the organic solvent at a concentration of about 0.3 Molar.

The optional support structure may help provide the polymer electrolyte 28 with mechanical stability and may comprise a microporous nonwoven material impregnated, infiltrated, and/or encapsulated in the polymer electrolyte 28. For example, the support structure may comprise a mat of nonwoven fibers. The fibers may comprise a polymer (e.g., a polyolefin and/or a polyamide), glass, or a combination thereof. For example, the support structure may comprise a mat of nonwoven fibers of polypropylene (PP), polyethylene (PE), and/or polyethyleneterephthalate (PET). The support may have a thickness of greater than or equal to 5 μm, optionally greater than or equal to 10 μm, and less than or equal to 200 μm, optionally less than or equal to 100 μm, or optionally less than or equal to 50 μm,

The negative electrode current collector 30 and the positive electrode current collector 32 are electrically conductive and provide an electrical connection between the external circuit 36 and the negative electrode 22 and the positive electrode 24, respectively. In aspects, the negative electrode current collector 30 and the positive electrode current collector 32 may be made of metal and may be in the form of nonporous metal foils, perforated metal foils, porous metal meshes, or a combination thereof. The negative electrode current collector 30 may be made of copper, nickel, or alloys thereof, stainless steel, or other appropriate electrically conductive material. The positive electrode current collector 32 may be made of aluminum (Al) or another appropriate electrically conductive material.

### Methods

The battery 20 may be manufactured by assembling a stack comprising the negative electrode 22 and the positive electrode 24, wherein the negative electrode 22 and the positive electrode 24 are spaced apart from each other by a gap, and infiltrating the stack with an electrolyte precursor, and then initiating free radical polymerization thereof. The electrolyte precursor comprises acrylamide monomers, the optional alkylene bisacrylamide crosslinker, the optional acrylonitrile monomer, a radical initiator, and a liquid electrolyte. The acrylamide monomers, the optional alkylene bisacrylamide crosslinker, the optional acrylonitrile monomer, and the liquid electrolyte may have substantially the same composition as the acrylamide monomer, the optional alkylene bisacrylamide crosslinker, the optional acrylonitrile monomer, and the liquid electrolyte described above with respect to the polymer electrolyte 28 and may be present in the electrolyte precursor in substantially the same proportions.

The radical initiator may comprise a thermal polymerization initiator or a photopolymerization initiator. Examples of thermal polymerization initiators include azo compounds, organic peroxides, and combinations thereof. Examples of azo compound initiators include azobisisobutyronitrile (AIBN), 1,1′-azobis(cyclohexanecarbonitrile) (ACHN), and combinations thereof. Examples of organic peroxide initiators include benzoyl peroxide, tert-butyl peroxyacetate, and combinations thereof. Examples of photopolymerization initiators include methyl benzoylformate (MBF). In embodiments, the radical initiator may comprise AIBN.

Free radical polymerization of the electrolyte precursor may be initiatiated such that the acrylamide monomers, the optional alkylene bisacrylamide crosslinker, and the optional acrylonitrile monomer covalently bond to one another and form a polyacrylamide. Free radical polymerization of the electrolyte precursor may be initiated, for example, by heating the electrolyte precursor and/or by irradiating the electrolyte precursor with ultraviolet (UV) light. In embodiments where free radical polymerization of the electrolyte precursor is initiated by heating, the electrolyte precursor may be heated at a temperature of greater than or equal to 50 degrees Celsius (° C.), optionally greater than or equal to 70° C., or optionally greater than or equal to 100° C.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

What is claimed is:

1. An electrolyte for a battery that cycles lithium ions, the electrolyte comprising:
a polyacrylamide comprising acrylamide monomers covalently bonded to one another;
a liquid electrolyte immobilized in the polyacrylamide, the liquid electrolyte comprising a lithium salt in an organic solvent.

2. The electrolyte of claim 1, wherein the acrylamide monomers comprise acrylamide, N-alkylacrylamide, N-cycloalkylacrylamide, dialkylacrylamide, hydroxyalkylacrylamides, N-arylacrylamides, methacrylamide, N-alkyl methacrylamide, N-cycloalkyl methacrylamide, dialkyl methacrylamide, dialkylaminoalkyl methacrylamide, hydroxyalkyl methacrylamide, N-arylmethacrylamide, 2-acrylamido-2-methyl-1-propanesulfonic acid, 2-acrylamido-2-methyl-propanephosphonic acid, or a combination thereof.

3. The electrolyte of claim 1, wherein at least one of the acrylamide monomers comprises a substituent selected from the group consisting of silyl, siloxy, alkoxysilyl, sulfo, phosphate, and carboxamide.

4. The electrolyte of claim 1, wherein the polyacrylamide further comprises an alkylene bisacrylamide crosslinker, and wherein the acrylamide monomers and the alkylene bisacrylamide crosslinker are covalently bonded to one another to form a three-dimensional network of interconnected polyacrylamide chains.

5. The electrolyte of claim 1, wherein the polyacrylamide further comprises an acrylonitrile monomer, and wherein the acrylamide monomers and the acrylonitrile monomer are covalently bonded to one another.

6. The electrolyte of claim 1, wherein the polyacrylamide comprises a polymer having the formula (1): 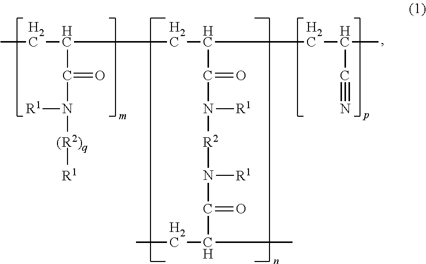
wherein:
m is an integer;
n is zero or an integer;
p is zero or an integer;
q is zero or 1;
R¹, R³, R⁴, and R⁵ are each individually H, hydroxyl, hydrocarbyl, heterohydrocarbyl, silyl, siloxy, alkoxysilyl, sulfo, phosphate, or carboxamide moiety;
R² is a divalent hydrocarbyl or heterohydrocarbyl, and
the sum of m+n+p is greater than or equal to 100 and less than or equal to 200,000.

7. The electrolyte of claim 1, wherein the organic solvent comprises an ether-based solvent, and wherein the lithium salt comprises lithium hexafluorophosphate (LiPF₆), lithium bis(trifluoromethane)sulfonylimide (LiTFSI), lithium bis(fluorosulfonyl)imide (LiFSI), or a combination thereof.

8. The electrolyte of claim 1, further comprising an additive comprising lithium nitrate (LiNO₃).

9. A battery that cycles lithium ions, the battery comprising:
a negative electrode comprising an electroactive negative electrode material;
a positive electrode spaced apart from the negative electrode by a gap, the positive electrode comprising an electroactive positive electrode material; and
a polymer electrolyte disposed within the gap between the negative electrode and the positive electrode, the polymer electrolyte comprising:
a polyacrylamide comprising acrylamide monomers covalently bonded to one another, and
a liquid electrolyte immobilized in the polyacrylamide, the liquid electrolyte comprising a lithium salt in an organic solvent.

10. The battery of claim 9, wherein the acrylamide monomers comprise acrylamide, N-alkylacrylamide, N-cycloalkylacrylamide, dialkylacrylamide, hydroxyalkylacrylamides, N-arylacrylamides, methacrylamide, N-alkyl methacrylamide, N-cycloalkyl methacrylamide, dialkyl methacrylamide, dialkylaminoalkyl methacrylamide, hydroxyalkyl methacrylamide, N-arylmethacrylamide, 2-acrylamido-2-methyl-1-propanesulfonic acid, 2-acrylamido-2-methyl-propanephosphonic acid, or a combination thereof.

11. The battery of claim 9, wherein at least one of the acrylamide monomers comprises a substituent selected from the group consisting of silyl, siloxy, alkoxysilyl, sulfo, phosphate, and carboxamide.

12. The battery of claim 9, wherein the polyacrylamide further comprises an alkylene bisacrylamide crosslinker, and wherein the acrylamide monomers and the alkylene bisacrylamide crosslinker are covalently bonded to one another to form a three-dimensional network of interconnected polyacrylamide chains.

13. The battery of claim 9, wherein the polyacrylamide further comprises an acrylonitrile monomer, and wherein the acrylamide monomers and the acrylonitrile monomer are covalently bonded to one another.

14. The battery of claim 9, wherein the polyacrylamide comprises a polymer having the formula (1): 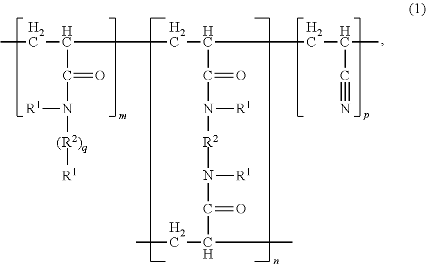
wherein:
m is an integer;
n is zero or an integer;
p is zero or an integer;
q is zero or 1;
R¹, R³, R⁴, and R⁵ are each individually H, hydroxyl, hydrocarbyl, heterohydrocarbyl, silyl, siloxy, alkoxysilyl, sulfo, phosphate, or carboxamide moiety;
R² is a divalent hydrocarbyl or heterohydrocarbyl, and
the sum of m+n+p is greater than or equal to 100 and less than or equal to 200,000.

15. The battery of claim 9, wherein the organic solvent comprises an ether-based solvent, and wherein the lithium salt comprises lithium hexafluorophosphate (LiPF₆), lithium bis(trifluoromethane)sulfonylimide (LiTFSI), lithium bis(fluorosulfonyl)imide (LiFSI), or a combination thereof.

16. The battery of claim 9, wherein the liquid electrolyte further comprises an additive comprising lithium nitrate (LiNO₃).

17. The battery of claim 9, wherein the electroactive positive electrode material comprises a sulfur-based material.

18. The battery of claim 9, wherein the electroactive negative electrode material comprises nonporous lithium.

19. A method of manufacturing a battery that cycles lithium ions, the method comprising:
assembling a stack comprising a negative electrode and a positive electrode, the negative electrode and the positive electrode being spaced apart from each other by a gap;
infiltrating the stack with an electrolyte precursor comprising acrylamide monomers, a radical initiator, and a liquid electrolyte; and
initiating free radical polymerization of the acrylamide monomers such that the acrylamide monomers covalently bond to one another and form a polyacrylamide.

20. The method of claim 19, wherein the radical initiator comprises an azo compound, an organic peroxide, or a combination thereof, and wherein free radical polymerization of the acrylamide monomers is initiated by heating the electrolyte precursor at a temperature of greater than or equal to 70 degrees Celsius.
